(19) United States
(12) Patent Application Publication
(10) Pub. No.: US 2022/0057792 A1
(43) Pub. Date: Feb. 24, 2022

(54) INTEGRATED MANIPULATION APPARATUS FOR AUTONOMOUS VEHICLES AND CONTROL METHOD THEREOF

(71) Applicants: HYUNDAI MOTOR COMPANY, Seoul (KR); KIA MOTORS CORPORATION, Seoul (KR); SL Corporation, Buk-gu (KR)

(72) Inventors: Eun Sik KIM, Gwangmyeong-si (KR); Seok Woo Ye, Dong-gu (KR); Jae Hoon Jung, Gyeongsan-si (KR); Ji Hoon Yang, Gyeongsan-si (KR)

(73) Assignees: HYUNDAI MOTOR COMPANY, Seoul (KR); KIA MOTORS COORPORATION, Seoul (KR); SL Corporation, Buk-gu (KR)

(21) Appl. No.: 17/147,064

(22) Filed: Jan. 12, 2021

(30) Foreign Application Priority Data
Aug. 18, 2020 (KR) 10-2020-0103506

(51) Int. Cl. G05D 1/00

(52) U.S. Cl. CPC G05D 1/0016; B60Q 5/001; G05D 1/005; G05D 1/0061

(57) ABSTRACT

An integrated manipulation apparatus for autonomous vehicles and a control method are provided. When a driving mode is switched from an autonomous driving mode to a manual driving mode, a user manipulates the integrated manipulation apparatus, which is portable, to perform chassis functions, such as steering, speed change, acceleration, and braking of a vehicle, and to perform general functions, such as lamp on/off, honking, and turn indication, as needed. A steering dial switch and a speed change slide switch are different in manipulation manner from an acceleration button switch and a braking button switch.

### CROSS-REFERENCE TO RELATED APPLICATION

The present application claims priority to and the benefit of Korean Patent Application No. 10-2020-0103506, filed on Aug. 18, 2020, the disclosure of which is herein incorporated by reference in its entirety.

### TECHNICAL FIELD

The present disclosure relates to an integrated manipulation apparatus for autonomous vehicles and a control method thereof, and more particularly to an integrated manipulation apparatus provided in an autonomous vehicle, the integrated manipulation apparatus being configured to be directly manipulated by a user when a driving mode is switched from an autonomous driving mode to a manual driving mode, and a control method thereof.

### BACKGROUND

An autonomous vehicle is a smart vehicle to which autonomous driving technology enabling the vehicle to move to a destination in the state in which a driver does not directly manipulate a steering wheel, an accelerator pedal, and a brake is applied.

In the case in which an autonomous driving situation is generally realized, it is possible to switch between a manual driving mode, in which a driver directly drives a vehicle, and an autonomous driving mode, in which a vehicle moves to a destination while a driver does not directly drive the vehicle.

Meanwhile, when an emergency situation occurs during autonomous driving, any one of passengers in a vehicle must directly manually manipulate the vehicle. To this end, the vehicle is provided with an apparatus configured to be manipulated by a user in the manual driving mode.

For example, a vehicle manager may manipulate a vehicle in the manual driving mode using a device used in a game console, such as a joystick.

The matters disclosed in this section are merely for enhancement of understanding of the general background of the disclosure and should not be taken as an acknowledgment or any form of suggestion that the matters form the related art already known to a person skilled in the art.

### SUMMARY

The present disclosure provides an integrated manipulation apparatus for autonomous vehicles configured to be manipulated by a user when a driving mode is switched from an autonomous driving mode to a manual driving mode, wherein the integrated manipulation apparatus includes a chassis function switch configured to be manipulated to perform steering, speed change, acceleration, and braking and a general function switch configured to be manipulated to perform lamp on/off, honking, and turn indication, whereby manipulation convenience is improved and unintentional manipulation is maximally prevented, and a control method thereof.

In accordance with an aspect of the present disclosure, an integrated manipulation apparatus for autonomous vehicles is provided when a driving mode is switched from an autonomous driving mode to a manual driving mode, the integrated manipulation apparatus including a housing configured to be held by the user in both hands, a chassis function switch provided at the housing, the chassis function switch being configured to be manipulated by the user in order to perform steering, speed change, acceleration, and braking, and a general function switch provided at the housing, the general function switch being configured to be manipulated by the user in order to perform lamp on/off, honking, and turn indication.

The integrated manipulation apparatus may further include a display provided at the housing, the display being configured to visually display information about a manipulated switch.

The integrated manipulation apparatus may further include a deadman switch provided at the housing, the deadman switch being configured to be manipulated by the user, wherein, only when the chassis function switch is manipulated in a state in which the deadman switch is manipulated, a function of the manipulated chassis function switch may be performed.

The integrated manipulation apparatus may further include a deadman switch provided at the housing, the deadman switch being configured to be manipulated by the user, wherein, when the chassis function switch is manipulated in a state in which the deadman switch is not manipulated, a function of the manipulated chassis function switch may not be performed.

The integrated manipulation apparatus may further include a deadman switch provided at the housing, the deadman switch being configured to be manipulated by the user, wherein, when the chassis function switch is manipulated in a state in which the deadman switch is not manipulated, a function of the manipulated chassis function switch may not be performed and at the same time a warning alarm may be provided to the user through the display.

The integrated manipulation apparatus may further include a deadman switch provided at the housing, the deadman switch being configured to be manipulated by the user, wherein, when the general function switch is manipulated, a function of the manipulated general function switch may be immediately performed irrespective of whether the deadman switch is manipulated.

The housing may include a first grip portion configured to be held by the user in one hand, a second grip portion configured to be held by the user in the other hand, the second grip portion being spaced apart from the first grip portion, and a switch portion configured to interconnect the first grip portion and the second grip portion, the chassis function switch, the general function switch, the display, and the deadman switch being provided at the switch portion.

The chassis function switch may include a steering dial switch provided at the upper surface of the switch portion in front of the first grip portion, the steering dial switch being configured to be manipulated by the user through rotation using a finger, an acceleration button switch and a braking button switch provided at the upper surface of the switch portion in front of the second grip portion, the acceleration button switch and the braking button switch being configured to be manipulated by the user through push using a finger, and a speed change slide switch provided at the front surface of the switch portion, the speed change slide switch being configured to be manipulated by the user through push or pull using a finger.

The steering dial switch, the acceleration button switch, and the speed change slide switch may be different in manipulation manner from each other in order to prevent unintentional manipulation, and the acceleration button switch and the braking button switch may be identical in manipulation manner to each other.

The integrated manipulation apparatus may further include a permanent magnet coupled to each of the steering dial switch, the acceleration button switch, the braking button, and the speed change slide switch and a printed circuit board (PCB) fixedly installed at the housing so as to face the permanent magnet, wherein the PCB may generate one of a signal related to steering, a signal related to acceleration, a signal related to braking, and a signal related to speed change through a change in magnetic flux based on a change in position of the permanent magnet.

The steering dial switch may be provided with a power handle configured to allow the user to rotate the steering dial switch using small force.

The acceleration button switch and the braking button switch may be installed parallel to each other while being inclined at a predetermined angle in a longitudinal direction of the second grip portion so as to be easily manipulated using the thumb of a hand holding the second grip portion.

The acceleration button switch and the braking button switch may be different in width and length from each other in order to prevent unintentional manipulation.

In order to prevent unintentional manipulation, an embossed surface of the acceleration button switch and an embossed surface of the braking button switch may be formed so as to be different from each other.

The general function switch may include an emergency light switch and a honking switch provided at the upper surface of the switch portion at the rear thereof so as to be spaced apart from each other in a leftward-rightward direction, a right turn signal switch provided at the front surface of the switch portion so as to be located in front of the steering dial switch, a left turn signal switch provided at the front surface of the switch portion so as to be located in front of the acceleration button switch and the braking button switch, and a headlamp switch and a fog lamp switch provided at the rear surface of the switch portion so as to be spaced apart from each other in the leftward-rightward direction.

The deadman switch may be located at the front surface of the switch portion so as to be located in front of the acceleration button switch and the braking button switch while being located above the left turn signal switch.

In order to prevent unintentional manipulation of the left turn signal switch and the deadman switch, the left turn signal switch may be installed so as to be inclined at a predetermined angle relative to an installation angle of the deadman switch.

In order to prevent unintentional manipulation, an embossed surface of the left turn signal switch and an embossed surface of the deadman switch may be formed so as to be different from each other.

The display may be located at the upper surface of the switch portion so as to be surrounded by the steering dial switch, the acceleration button switch, the emergency light switch, and the honking switch.

In accordance with another aspect of the present disclosure, there is provided a control method of an integrated manipulation apparatus for autonomous vehicles including a chassis function switch including a steering dial switch, an acceleration button switch, a braking button switch, and a speed change slide switch, a general function switch including an emergency light switch, a honking switch, a right turn signal switch, a left turn signal switch, a headlamp switch, and a fog lamp switch, a deadman switch, a display, and a PCB configured to process a signal of each switch, the control method including, only when a signal of the chassis function switch is generated in the state in which a signal of the deadman switch is generated, the PCB processing the signal of the chassis function switch such that a function of the chassis function switch is performed.

The control method may further include, when a signal of the chassis function switch is generated in the state in which no signal of the deadman switch is generated, the PCB not processing the signal of the chassis function switch such that a function of the chassis function switch is not performed and providing a warning alarm to a user through the display.

When a signal of the general function switch is generated, the PCB may immediately process the signal of the general function switch such that a function of the general function switch is performed irrespective of whether the signal of the deadman switch is generated.

When a signal of the acceleration button switch and a signal of the braking button switch are simultaneously generated, the PCB may process the signal of the braking button switch earlier than the signal of the acceleration button switch.

When a signal of a transmission gear indicating that the driving direction of a vehicle is changed is generated in the state in which no signal of the braking button switch is generated while the vehicle drives, the PCB may generate a signal for forcibly finishing driving of the vehicle and may provide an alarm requesting the user to check the transmission gear through the display.

The signal of the transmission gear indicating that the driving direction of the vehicle is changed may be one of an R-gear signal generated in the state in which the current transmission gear is D and a D-gear signal generated in the state in which the current transmission gear is R.

### DRAWINGS

The above and other objects, features and other advantages of the present disclosure will be more clearly understood from the following detailed description taken in conjunction with the accompanying drawings, in which:

FIG. 1 is a view showing an autonomous vehicle having an integrated manipulation apparatus provided therein in one form of the present disclosure;

FIG. 2 is a perspective view of an integrated manipulation apparatus in one form of the present disclosure;

FIG. 3 is a perspective view of FIG. 2 when viewed from the front;

FIG. 4 is a plan view of FIG. 2;

FIG. 5 is a left side view of FIG. 4;

FIG. 6 is a view showing the state in which a housing is removed from FIG. 3; and

FIG. 7 is an exploded perspective view of FIG. 6.

### DETAILED DESCRIPTION

Specific structural or functional descriptions of the embodiments of the present disclosure disclosed in this specification or this disclosure are given only for illustrating embodiments of the present disclosure. Embodiments of the present disclosure may be realized in various forms, and should not be interpreted to be limited to the embodiments of the present disclosure disclosed in this specification or this disclosure.

Since the embodiments of the present disclosure may be variously modified and may have various forms, specific embodiments will be shown in the drawings and will be described in detail in this specification or this disclosure. However, the embodiments according to the concept of the present disclosure are not limited to such specific embodiments, and it should be understood that the present disclosure includes all alterations, equivalents, and substitutes that fall within the idea and technical scope of the present disclosure.

It will be understood that, although the terms “first”, “second”, etc. may be used herein to describe various elements, corresponding elements should not be understood to be limited by these terms, which are used only to distinguish one element from another. For example, within the scope defined by the present disclosure, a first element may be referred to as a second element, and similarly, a second element may be referred to as a first element.

It will be understood that, when a component is referred to as being “connected to” or “coupled to” another component, it may be directly connected to or coupled to the other component, or intervening components may be present. In contrast, when a component is referred to as being “directly connected to” or “directly coupled to” another component, there are no intervening components present. Other terms that describe the relationship between components, such as “between” and “directly between” or “adjacent to” and “directly adjacent to”, must be interpreted in the same manner.

The terms used in this specification are provided only to explain specific embodiments, but are not intended to restrict the present disclosure. A singular representation may include a plural representation unless it represents a definitely different meaning from the context. It will be further understood that the terms “comprises”, “has” and the like, when used in this specification, specify the presence of stated features, numbers, steps, operations, elements, components or combinations thereof, but do not preclude the presence or addition of one or more other features, numbers, steps, operations, elements, components, or combinations thereof.

Unless otherwise defined, all terms, including technical and scientific terms, used in this specification have the same meanings as those commonly understood by a person having ordinary skill in the art to which the present disclosure pertains. It will be further understood that terms, such as those defined in commonly used dictionaries, should be interpreted as having meanings consistent with their meanings in the context of the relevant art and the present disclosure, and are not to be interpreted in an idealized or overly formal sense unless expressly so defined herein.

A controller (control device) in some forms of the present disclosure may be realized by a non-volatile memory (not shown) configured to store an algorithm configured to control the operation of various elements of a vehicle or data on software commands for executing the algorithm and a processor (not shown) configured to perform the operation, which will be described below, using the data stored in the memory. Here, the memory and the processor may be realized as individual chips. Alternatively, the memory and the processor may be realized as a single integrated chip. The processor may include one or more processors.

Hereinafter, an integrated manipulation apparatus for autonomous vehicles in some forms of the present disclosure and a control method thereof will be described with reference to the accompanying drawings.

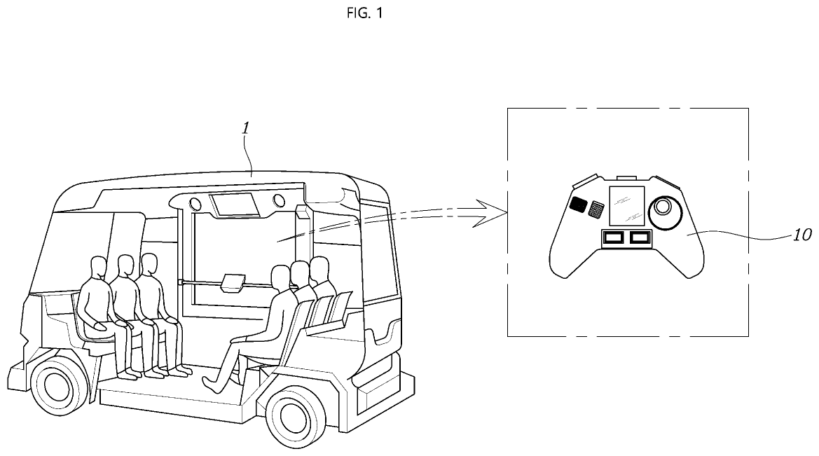

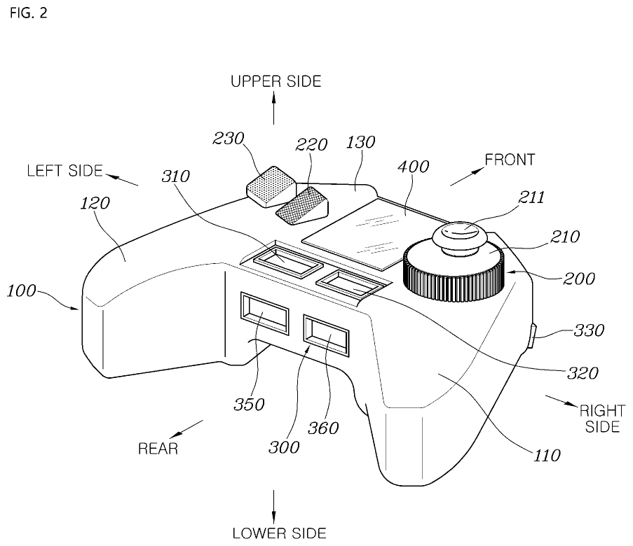

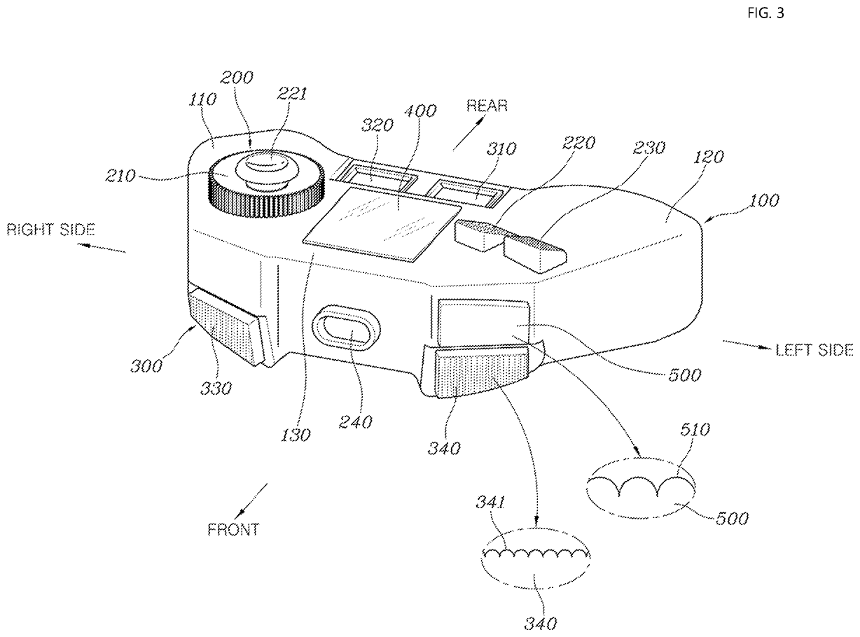

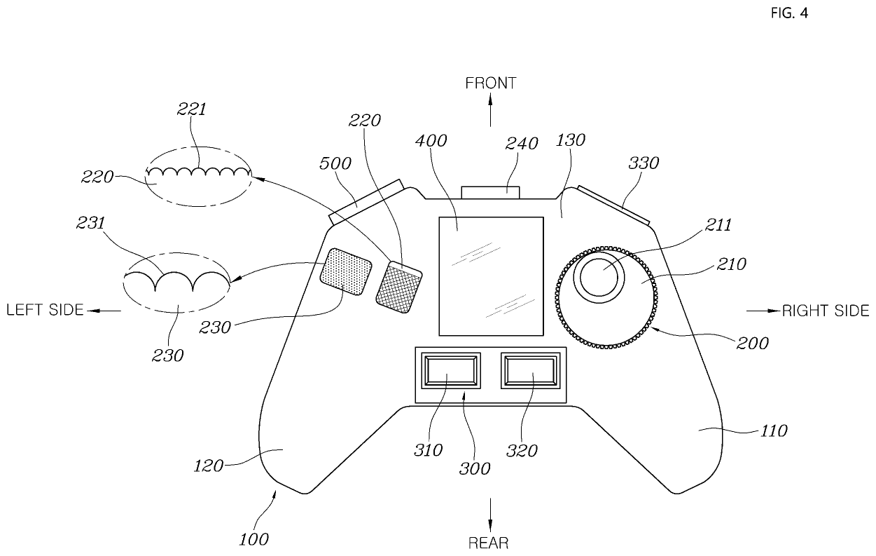

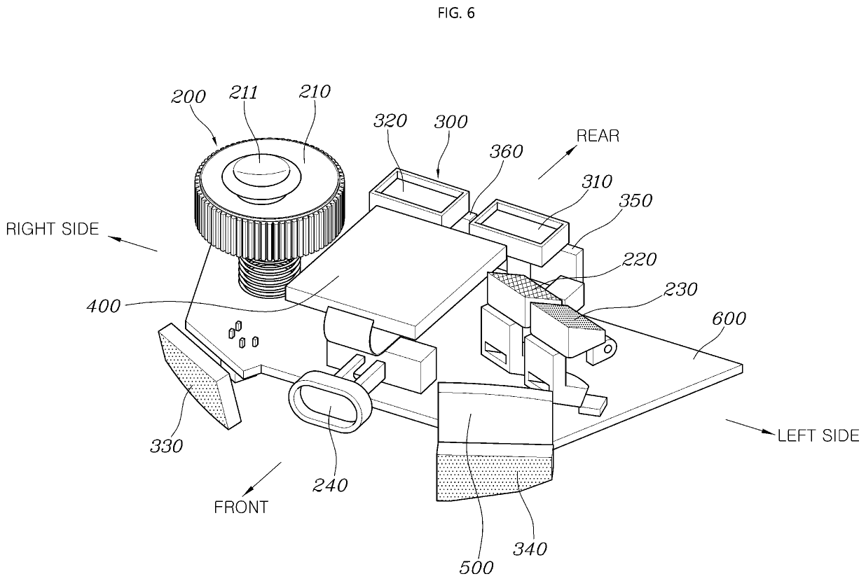

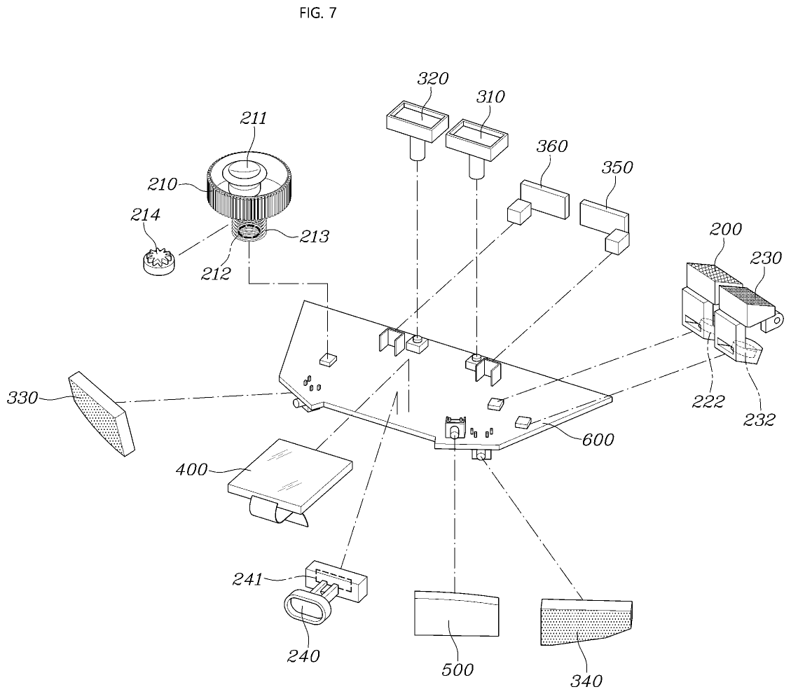

As shown in FIGS. 1 to 7, the integrated manipulation apparatus 10 for autonomous vehicles in some forms of the present disclosure is provided in an autonomous vehicle 1, and is an apparatus that a vehicle manager directly manipulates to drive the vehicle in a manual driving mode in the case in which an urgent situation occurs during autonomous driving.

The integrated manipulation apparatus 10 in some forms of the present disclosure is a portable manipulation apparatus that a user can move to a desired position while holding the apparatus in their hands. The integrated manipulation apparatus 10 may be connected to a controller of the autonomous vehicle via a wire to transmit a signal, or may be configured to transmit a signal using wireless communication. The integrated manipulation apparatus 10 is easy to manipulate, since the apparatus is small and light.

That is, the integrated manipulation apparatus 10 in some forms of the present disclosure includes a housing 100 configured to be held by a user in both hands, a chassis function switch 200 provided at the housing 100, the chassis function switch 200 being configured to be manipulated by the user in order to perform steering, speed change, acceleration, and braking, a general function switch 300 provided at the housing 100, the general function switch 300 being configured to be manipulated by the user in order to perform lamp on/off, honking, and turn indication, a display 400 provided at the housing 100, the display 400 being configured to visually display information about a manipulated switch, and a deadman switch 500 provided at the housing 100, the deadman switch 500 being configured to be manipulated by the user.

The deadman switch 500 is a switch that the user manipulates to perform steering, speed change, acceleration, and braking when the chassis function switch 200 is manipulated. Only when the user manipulates the chassis function switch 200 in the state in which the deadman switch 500 is manipulated, a function of the manipulated chassis function switch 200 is performed.

When the user manipulates the chassis function switch 200 in the state in which the deadman switch 500 is not manipulated, the function of the manipulated chassis function switch 200 is not performed. At this time, a warning alarm (text or figure) is provided to the user through the display 400.

That is, a function corresponding to each of steering, speed change, acceleration, and braking of the vehicle is a main factor that is connected directly with passenger safety. In consideration of safety of the passenger, the chassis function switch 200 is manipulated only in the state in which the deadman switch 500 is manipulated.

When the user manipulates the general function switch 300, on the other hand, the function of the manipulated general function switch 300 is immediately performed irrespective of whether the deadman switch 500 is manipulated.

That is, a function corresponding to each of lamp on/off, honking, and turn indication of the vehicle is a subsidiary factor that is not connected directly with safety of the passenger. When the user manipulates the general function switch 300 in the state in which the deadman switch 500 is manipulated, the function of the manipulated general function switch 300 is immediately performed. In addition, when the user manipulates the general function switch 300 in the state in which the deadman switch 500 is not manipulated, the function of the manipulated general function switch 300 is also immediately performed.

The housing 100 of the integrated manipulation apparatus 10 in some forms of the present disclosure includes a first grip portion 110 configured to be held by the user in one hand, a second grip portion 120 configured to be held by the user in the other hand, the second grip portion 120 being spaced apart from the first grip portion 110, and a switch portion 130 configured to interconnect the first grip portion 110 and the second grip portion 120, the chassis function switch 200, the general function switch 300, the display 400, and the deadman switch 500 being provided at the switch portion 130.

When describing the case in which the user is a right-handed person by way of example, the user may hold the first grip portion 110 in the right hand and may hold the second grip portion 120 in the left hand.

The chassis function switch 200 in some forms of the present disclosure includes a steering dial switch 210 provided at the upper surface of the switch portion 130 in front of the first grip portion 110, the steering dial switch 210 being configured to be manipulated by the user through rotation using a finger, an acceleration button switch 220 and a braking button switch 230 provided at the upper surface of the switch portion 130 in front of the second grip portion 120, the acceleration button switch 220 and the braking button switch 230 being configured to be manipulated by the user through push using a finger, and a speed change slide switch 240 provided at the front surface of the switch portion 130, the speed change slide switch 240 being configured to be manipulated by the user through push or pull using a finger.

In the present disclosure, the steering dial switch 210, the acceleration button switch 220, and the speed change slide switch 240 are different in manipulation manner from each other in order to prevent unintentional manipulation. The acceleration button switch 220 and the braking button switch 230, which are buttons configured to be manipulated in order to accelerate and decelerate the vehicle, are identical in manipulation manner to each other in order to maintain consistency in manipulation. However, the acceleration button switch 220 and the braking button switch 230 may be different in manipulation manner from each other as needed.

The user may manipulate the steering dial switch 210 by rotating the steering dial switch 210 using all fingers of the right hand in the state of holding the second grip portion 120 in the left hand.

The steering dial switch 210 may be provided with a power handle 211 configured to allow the user to rotate the steering dial switch 210 using small force.

The upper surface of the power handle 211 is formed so as to be concave such that the user puts a finger thereon. When the user puts the thumb or the index finger of the right hand on the upper surface of the power handle 211 and applies small rotational force thereto, the entirety of the steering dial switch 210 may be rotated relative to the housing 100.

A permanent magnet 220 is coupled to the steering dial switch 210. The permanent magnet 220 is installed so as to face a printed circuit board (PCB) 600 fixed to the housing 100. When the user rotates the steering dial switch 210, therefore, the position of the permanent magnet 220 is changed, and the PCB 600 generates a signal related to steering through a change in magnetic flux based on a change in position of the permanent magnet 220.

The steering dial switch 210 is rotated in the clockwise direction or in the counterclockwise direction relative to the housing 100 when manipulated by the user. When user manipulation force is released, the steering dial switch 210 is rotated in the opposite direction to return to the initial position thereof by spring force of a return spring 213.

In addition, a damper 214 is engaged with the steering dial switch 210 in the form of an external gear. The damper 214 serves to reduce the return speed of the steering dial switch 210 based on spring force to thus prevent noise and impact.

The acceleration button switch 220 and the braking button switch 230 are provided at the upper surface of the switch portion 130 in front of the second grip portion 120 in the state of being exposed upwards from the housing 100. The user manipulates the acceleration button switch 220 and the braking button switch 230 using the thumb of the left hand holding the second grip portion 120.

To this end, each of the acceleration button switch 220 and the braking button switch 230 is installed so as to be inclined at a predetermined angle in a longitudinal direction of the second grip portion 120 such that the acceleration button switch 220 and the braking button switch 230 can be easily manipulated using the thumb of the left hand of the user holding the second grip portion 120. Preferably, each of the acceleration button switch 220 and the braking button switch 230 is installed so as to be inclined at an angle of about 45 degrees such that the acceleration button switch 220 and the braking button switch 230 can be easily manipulated using the thumb of the left hand holding the second grip portion 120 in consideration of ergonomic characteristics. However, the present disclosure is not limited thereto.

In addition, the braking button switch 230 is located at the side of the acceleration button switch 220. Preferably, the acceleration button switch 220 and the braking button switch 230 are installed parallel to each other in consideration of ergonomic characteristics. However, the present disclosure is not limited thereto.

The acceleration button switch 220 and the braking button switch 230 may be different in width and length from each other in order to prevent unintentional manipulation.

That is, the portion of each of the acceleration button switch 220 and the braking button switch 230 that protrudes upwards from the housing 100 may be rectangular. In this case, the width of the acceleration button switch 220 may be less than the width of the braking button switch 230, and the length of the acceleration button switch 220 may be greater than the length of the braking button switch 230.

In the case in which the acceleration button switch 220 and the braking button switch 230 are configured so as to have different widths and lengths, as described above, intuition is improved and thus unintentional manipulation is prevented.

Also, in order to prevent unintentional manipulation of the user, an embossed surface 221 of the acceleration button switch 220 and an embossed surface 231 of the braking button switch 230 may be formed so as to be different from each other.

The acceleration button switch 220 and the braking button switch 230 are installed in the same construction. That is, the upper end of each of the acceleration button switch 220 and the braking button switch 230 is rotatably installed at the housing 100 via a rotary shaft, a return spring is wound around the rotary shaft, one end of the return spring is fixedly coupled to the housing 100, and the other end of the return spring is fixedly coupled to a corresponding one of the acceleration button switch 220 and the braking button switch 230.

Permanent magnets 222 and 232 are coupled to lower ends of the acceleration button switch 220 and the braking button switch 230 so as to face the PCB 600.

When the user pushes the upper surface of the acceleration button switch 220 or the braking button switch 230 using the thumb of the left hand holding the second grip portion 120, therefore, the acceleration button switch 220 or the braking button switch 230 is rotated about the rotary shaft, and the positions of the permanent magnets 222 and 232 are changed by rotation of the acceleration button switch 220 or the braking button switch 230. The PCB 600 recognizes rotation of the acceleration button switch 220 or the braking button switch 230 through a change in magnetic flux based on a change in position of the permanent magnets 222 and 232, and generates a signal related to acceleration or braking.

Each of the acceleration button switch 220 and the braking button switch 230 is a pedal type button switch having an upper end configured to be turnable relative to the housing about the rotary shaft.

The speed change slide switch 240 is provided at the front surface of the switch portion 130. The user may push or pull the speed change slide switch 240 in a leftward-rightward direction using the thumb or the index finger of the right hand in the state of holding the second grip portion 120 in the left hand in order to manipulate the speed change slide switch 240.

The speed change slide switch 240 is installed so as to be slidable relative to the housing 100 leftwards and rightwards. The speed change slide switch 240 is provided with a return spring. When user manipulation force is released, the speed change slide switch 240 returns to the neutral position thereof.

The speed change slide switch 240 is also provided with a permanent magnet 241. The permanent magnet 241 is installed so as to face the PCB 600. When the user pushes or pulls the speed change slide switch 240, the position of the permanent magnet 241 is changed. The PCB 600 recognizes movement of the speed change slide switch 240 through a change in magnetic flux based on a change in position of the permanent magnet 241, and generates a signal related to speed change.

The general function switch 300 in some forms of the present disclosure includes an emergency light switch 310 and a honking switch 320 provided at the upper surface of the switch portion 130 at the rear thereof so as to be spaced apart from each other in a leftward-rightward direction, a right turn signal switch 330 provided at the front surface of the switch portion 130 so as to be located in front of the steering dial switch 210, a left turn signal switch 340 provided at the front surface of the switch portion 130 so as to be located in front of the acceleration button switch 220 and the braking button switch 230, and a headlamp switch 350 and a fog lamp switch 360 provided at the rear surface of the switch portion 130 so as to be spaced apart from each other in the leftward-rightward direction.

Each of the emergency light switch 310, the honking switch 320, the right turn signal switch 330, the left turn signal switch 340, the headlamp switch 350, and the fog lamp switch 360 constituting the general function switch 300 is a tactile switch configured to be manipulated as the result of being pushed by a finger of the user. The tactile switch is a switch that is small, is easily returned to the initial position thereof by a rubber spring provided therein, and outputs a signal in a contact manner when manipulated.

The emergency light switch 310 and the honking switch 320, which are components of the general function switch that are frequently used, are located at the upper surface of the switch portion 130 at the rear of the display 400, and are located between the steering dial switch 210 and the acceleration button switch 220 and the braking button switch 230.

In the state in which the user manipulates the acceleration button switch 220, the braking button switch 230, or the deadman switch 500 using a finger of the left hand while holding the second grip portion 120 in the left hand, the user may take the right hand off the steering dial switch 210 and may then easily manipulate the emergency light switch 310 or the honking switch 320.

For reference, the autonomous vehicle drives at a low speed when the user manipulates the integrated manipulation apparatus 10. In the state in which the user manipulates the acceleration button switch 220, the braking button switch 230, or the deadman switch 500 using the finger of the left hand holding the second grip portion 120, therefore, the user may take the right hand off the steering dial switch 210 and may then manipulate the emergency light switch 310 or the honking switch 320 using the thumb or the index finger of the right hand.

The headlamp switch 350 and the fog lamp switch 360, which are components of the general function switch that are used under specific conditions, are located at the rear surface of the switch portion 130, which is minimally exposed to the user.

In the state in which the user manipulates the acceleration button switch 220, the braking button switch 230, or the deadman switch 500 using a finger of the left hand while holding the second grip portion 120 in the left hand, the user may take the right hand off the steering dial switch 210 and may then manipulate the emergency light switch 310 or the honking switch 320.

The right turn signal switch 330 and the left turn signal switch 340, which are components of the general function switch that are the most frequently used, are manipulated using the middle finger of the right hand and the middle finger of the left hand of the user, respectively.

The right turn signal switch 330 is configured to be manipulated using a finger of the right hand even in the state in which the user manipulates the steering dial switch 210 using the right hand. To this end, the right turn signal switch 330 is located at the front surface of the switch portion 130 in front of the steering dial switch 210.

The left turn signal switch 340 is configured to be manipulated using a finger of the left hand even in the state in which the user manipulates the acceleration button switch 220, the braking button switch 230, or the deadman switch 500 using the left hand. To this end, the left turn signal switch 340 is located at the front surface of the switch portion 130 in front of the acceleration button switch 220 and the braking button switch 230.

The deadman switch 500 is configured to be manipulated using the index finger or the middle finger of the left hand holding the second grip portion 120. To this end, the deadman switch 500 is located at the front surface of the switch portion 130 so as to be located in front of the acceleration button switch 220 and the braking button switch 230 while being located above the left turn signal switch 340.

In order to prevent unintentional manipulation of the left turn signal switch 340 and the deadman switch 500, the left turn signal switch 340 is installed so as to be inclined at a predetermined angle Al relative to the installation angle of the deadman switch 500.

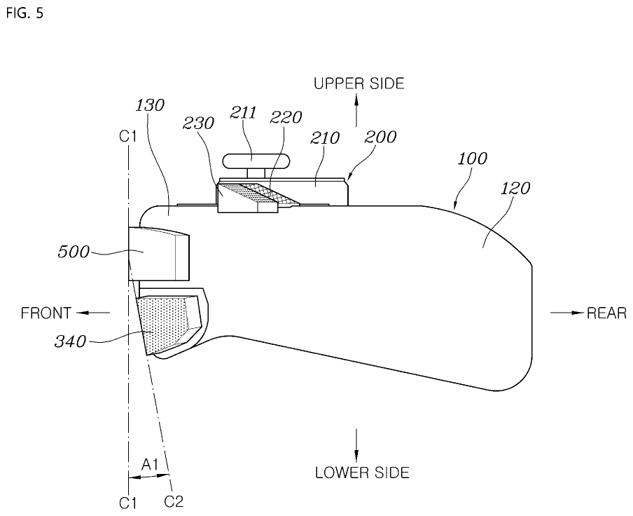

That is, the deadman switch 500 is installed at the front surface of the switch portion 130 at the right angle in an upward-downward direction (a reference line Cl of FIG. 5), the left turn signal switch 340 is installed so as to be inclined along a reference line C2 rotated the predetermined angle A1 rearwards from the installation reference line C1 of the deadman switch 500. As a result, intuition of the left turn signal switch 340 and the deadman switch 500 at the time of manipulation is improved, whereby unintentional manipulation is prevented.

Also, in order to prevent unintentional manipulation by the user, an embossed surface 341 of the left turn signal switch 340 and an embossed surface 510 of the deadman switch 500 may be formed so as to be different from each other.

The display 400 is located at the upper surface of the switch portion 130 so as to be surrounded by the steering dial switch 210, the acceleration button switch 220, the emergency light switch 310, and the honking switch 320 such that the user can more easily visually recognize the display 400.

Hereinafter, a control method of the integrated manipulation apparatus 10 for autonomous vehicles in some forms of the present disclosure will be described.

The control method of the integrated manipulation apparatus 10 for autonomous vehicles in some forms of the present disclosure is characterized in that, only when a signal of the chassis function switch 200 is generated in the state in which a signal of the deadman switch 500 is generated, the PCB 600 processes the signal of the chassis function switch 200 such that the function of the manipulated chassis function switch 200 is performed.

In addition, when a signal of the chassis function switch 200 is generated in the state in which no signal of the deadman switch 500 is generated, the PCB 600 does not process the signal of the chassis function switch 200 and provides a warning alarm to the user through the display 400 such that the function of the manipulated chassis function switch 200 is not performed.

When a signal of the general function switch 300 is generated irrespective of whether a manipulation signal of the deadman switch 500 is generated, the PCB 600 immediately processes the signal of the general function switch 300 such that the function of the manipulated general function switch 300 is performed.

When a signal of the acceleration button switch 220 and a signal of the braking button switch 230 are simultaneously generated, the PCB 600 processes the signal of the braking button switch 230 earlier than the signal of the acceleration button switch 220 for safety of the passenger.

A chassis function directly connected with safety of the passenger is a braking function, rather than an acceleration function. In the case in which an acceleration signal and a braking signal are simultaneously generated, therefore, the PCB 600 processes the braking signal earlier than the acceleration signal in consideration of passenger safety.

When a signal of a transmission gear indicating that a driving direction of the vehicle is changed is generated in the state in which no signal of the braking button switch 230 is generated while the vehicle drives, the PCB 600 generates a signal for forcibly finishing driving of the vehicle and provides an alarm requesting the user to check the transmission gear through the display 400, whereby driving stability is secured.

Here, the signal of the transmission gear indicating that the driving direction of the vehicle is changed is an R-gear signal generated in the state in which the current transmission gear is D or a D-gear signal generated in the state in which the current transmission gear is R.

In some forms of the present disclosure described above, when the driving mode is switched from the autonomous driving mode to the manual driving mode, the user manipulates the integrated manipulation apparatus 10, which is portable, to perform chassis functions, such as steering, speed change, acceleration, and braking of the vehicle, and to perform general functions, such as lamp on/off, honking, and turn indication, as needed. The integrated manipulation apparatus is easy and convenient to manipulate.

In addition, the integrated manipulation apparatus 10 in some forms of the present disclosure is a portable manipulation apparatus that the user can move to a desired position while holding the apparatus in their hands. The integrated manipulation apparatus is small and light, and therefore it is possible to easily manipulate the integrated manipulation apparatus.

Also, in the integrated manipulation apparatus 10 in some forms of the present disclosure, the steering dial switch 210 and the speed change slide switch 240 are different in manipulation manner from the acceleration button switch 220 and the braking button switch 230. Consequently, it is possible to maximally prevent unintentional manipulation.

As is apparent from the above description, an integrated manipulation apparatus in some forms of the present disclosure has an effect in that, when a driving mode is switched from an autonomous driving mode to a manual driving mode, a user manipulates the integrated manipulation apparatus in the state of carrying the integrated manipulation apparatus to perform chassis functions, such as steering, speed change, acceleration, and braking of a vehicle, and to perform general functions, such as lamp on/off, honking, and turn indication, as needed, whereby the integrated manipulation apparatus is easy and convenient to manipulate.

In addition, the integrated manipulation apparatus in some forms of the present disclosure is a portable manipulation apparatus that the user can move to a desired position while holding the apparatus in their hands. The integrated manipulation apparatus is small and light, and therefore it is possible to easily manipulate the integrated manipulation apparatus.

Also, in the integrated manipulation apparatus in some forms of the present disclosure, a steering dial switch and a speed change slide switch are different in manipulation manner from an acceleration button switch and a braking button switch. Consequently, it is possible to maximally prevent unintentional manipulation.

Although the preferred embodiments of the present disclosure have been described above with reference to the accompanying drawings, those skilled in the art will appreciate that the present disclosure can be implemented in various other embodiments without changing the technical ideas or features thereof.

What is claimed is:

1. An integrated manipulation apparatus manipulated by a user when a driving mode is switched from an autonomous driving mode to a manual driving mode, the integrated manipulation apparatus comprising:
a housing configured to be held by the user in both hands;
a chassis function switch provided at the housing, the chassis function switch being configured to perform steering, speed change, acceleration, and braking;
a general function switch provided at the housing, the general function switch being configured to perform lamp on/off, honking, and turn indication;
a display provided at the housing, the display being configured to visually display information about a manipulated switch; and
a deadman switch provided at the housing, the deadman switch being configured to be manipulated by the user, wherein the chassis function switch is further configured to:
perform the steering, the speed change, the acceleration, and the braking only when the chassis function switch and the deadman switch are manipulated; and
not perform the steering, the speed change, the acceleration, and the braking when the chassis function switch is manipulated and the deadman switch is not manipulated, wherein the display is configured to provide a warning alarm to the user.

2. The integrated manipulation apparatus according to claim 1, wherein the general function switch is configured to:
perform the lamp on/off, the honking, and the turn indication immediately when the general function switch is manipulated irrespective of whether the deadman switch is manipulated.

3. The integrated manipulation apparatus according to claim 1, wherein the housing further comprises:
a first grip portion configured to be held by the user in a first hand;
a second grip portion configured to be held by the user in a second hand, the second grip portion being spaced apart from the first grip portion; and
a switch portion configured to interconnect the first grip portion and the second grip portion, the switch portion including the chassis function switch, the general function switch, the display, and the deadman switch.

4. The integrated manipulation apparatus according to claim 3, wherein the chassis function switch further comprises:
a steering dial switch provided at an upper surface of the switch portion in front of the first grip portion, the steering dial switch being controlled by rotating a finger;
an acceleration button switch and a braking button switch provided at the upper surface of the switch portion in front of the second grip portion, the acceleration button switch and the braking button switch being controlled by pushing the finger; and
a speed change slide switch provided at a front surface of the switch portion, the speed change slide switch being controlled by pushing or pulling the finger.

5. The integrated manipulation apparatus according to claim 4, wherein the steering dial switch, the acceleration button switch, and the speed change slide switch are different in manipulation manner in order to prevent unintentional manipulation, and the acceleration button switch and the braking button switch are identical in manipulation manner.

6. The integrated manipulation apparatus according to claim 4, further comprising:
a permanent magnet coupled to each of the steering dial switch, the acceleration button switch, the braking button, and the speed change slide switch; and
a printed circuit board (PCB) fixedly installed at the housing to face the permanent magnet, wherein
the PCB is configured to generate one of a signal related to steering, a signal related to acceleration, a signal related to braking, or a signal related to speed change through a change in magnetic flux based on a change in position of the permanent magnet.

7. The integrated manipulation apparatus according to claim 4, wherein the steering dial switch is provided with a power handle that is configured to allow the user to rotate the steering dial switch using a small force.

8. The integrated manipulation apparatus according to claim 4, wherein the acceleration button switch and the braking button switch are installed parallel to each other while being inclined at a predetermined angle in a longitudinal direction of the second grip portion so as to be easily manipulated using a thumb of the second hand.

9. The integrated manipulation apparatus according to claim 4, wherein the acceleration button switch and the braking button switch are different in width and length from each other in order to prevent unintentional manipulation.

10. The integrated manipulation apparatus according to claim 4, wherein the acceleration button switch and the braking button switch are configured to form a different embossed surface from each other in order to prevent unintentional manipulation.

11. The integrated manipulation apparatus according to claim 4, wherein the general function switch further comprises:
an emergency light switch and a honking switch provided from the upper surface of the switch portion to a rear surface of the switch portion to be spaced apart from each other in a leftward-rightward direction;
a right turn signal switch provided at the front surface of the switch portion to be located in front of the steering dial switch;
a left turn signal switch provided at the front surface of the switch portion to be located in front of the acceleration button switch and the braking button switch; and
a headlamp switch and a fog lamp switch provided at the rear surface of the switch portion to be spaced apart from each other in the leftward-rightward direction.

12. The integrated manipulation apparatus according to claim 11, wherein the deadman switch is located at the front surface of the switch portion to be located in front of the acceleration button switch and the braking button switch while being located above the left turn signal switch.

13. The integrated manipulation apparatus according to claim 12, wherein, in order to prevent unintentional manipulation of the left turn signal switch and the deadman switch, the left turn signal switch is installed to be inclined at a predetermined angle relative to an installation angle of the deadman switch.

14. The integrated manipulation apparatus according to claim 12, wherein the left turn signal and the deadman switch are configured to form a different embossed surface from each other in order to prevent unintentional manipulation.

15. The integrated manipulation apparatus according to claim 11, wherein the display is located at the upper surface of the switch portion to be surrounded by the steering dial switch, the acceleration button switch, the emergency light switch, and the honking switch.

16. A control method of an integrated manipulation apparatus for autonomous vehicles the control method comprising:
only when a signal of a chassis function switch and a signal of a deadman switch are generated, performing, by the chassis function switch, a steering, a speed change, an acceleration and a braking; and
when the signal of the chassis function switch is generated and the signal of the deadman switch is not generated, not performing, by the chassis function switch, the steering, the speed change, the acceleration and the braking, and providing, by a display, a warning alarm to a user.

17. The control method according to claim 16, wherein, when a signal of the general function switch is generated, performing, by the general function switch, a lamp on/off, a honking and a turn indication immediately irrespective of whether the signal of the deadman switch is generated.

18. The control method according to claim 16, wherein the control method further comprises:
generating a signal of the acceleration button switch and a signal of the braking button switch simultaneously; and
when the signal of the acceleration button switch and the signal of the braking button switch are simultaneously generated, processing, by a printed circuit board (PCB), the signal of the braking button switch earlier than the signal of the acceleration button switch.

19. The control method according to claim 16, wherein, when a signal of a transmission gear indicating that a driving direction of a vehicle is changed is generated and a signal of the braking button switch is not generated while the vehicle drives, generating, by a printed circuit board (PCB), a signal for forcibly finishing driving of the vehicle and providing, by the display, an alarm requesting the user to check the transmission gear.

20. The control method according to claim 19, wherein the signal of the transmission gear includes one of an R-gear signal generated in a state in which a current transmission gear is D or a D-gear signal generated in a state in which the current transmission gear is R.
